(19) United States
(12) Patent Application Publication
(10) Pub. No.: US 2003/0047276 A1
(43) Pub. Date: Mar. 13, 2003

(54) Method of installing a tubular member in a cavity inaccessible to an operator

(75) Inventors: Peter Friedrich, Triel Sur Seine (FR); Klaus Nothofer, Erkrath (DE); Bernard Wurier, Valmondois (FR); Philippe Gauthier, Muret (FR)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/236,912

(22) Filed: Sep. 9, 2002

(30) Foreign Application Priority Data
Sep. 10, 2001 (FR) 01 11 666
Sep. 10, 2001 (FR) 01 11 667

(51) Int. Cl. B29C 63/34

(52) U.S. Cl. 156/281; 156/294

(57) ABSTRACT

A method of installing a tubular member in an inaccessible cavity includes a step of cleaning the internal wall of the cavity, a step of bringing the tubular member into contact with retaining members, and a step of fixing the tubular member by pressing it against the wall of the cavity. The method comprises three successive phases. A first phase comprises the step of cleaning the internal wall of the cavity and a step of topographically surveying the internal wall of the cavity. A second phase comprises a step of determining a position on the internal wall for retaining members for retaining the tubular member and a step of installing on the internal wall retaining members for retaining the tubular member and fixing members for fixing the retaining members to the wall. A third phase of guiding and installing the tubular member into the retaining members comprises the step of bringing the tubular member into contact with the retaining members and the step of fixing the tubular member by pressing it against the internal wall.

### CROSS-REFERENCE TO RELATED APPLICATIONS

This application is based on French Patent Application No. 01 11 666 and 01 11 667 filed Sep. 10, 2001, the disclosure of which is hereby incorporated by reference thereto in its entirety, and the priority of which is hereby claimed under 35 U.S.C. §119.

### BACKGROUND OF THE INVENTION

1. Field of the invention

The present invention relates to a method of installing a tubular member, such as a pipe intended to accommodate one or more cables, in a cavity inaccessible to an operator, such as a tubular area like a network of pipes, pipelines or conduits, for example for collecting wastewater. In the tubular areas, the inaccessibility is the result of the dimensions of the cross section being too small. The invention relates more particularly to operations carried out in small-diameter (meaning in particular diameters less than 200 mm) non-pressurized underground tubular areas, such as a drain or an outlet pipe from a building, in which direct visual and material access is impossible.

2. Description of the prior art

A tubular member, such as a pipe intended to accommodate one or more cables, is usually installed in an inaccessible and generally tubular cavity by a method that usually includes three main phases.

A first phase consists of preparing the internal wall of the cavity to receive the tubular member. This phase is primarily a phase of exploring and cleaning the walls of the cavity. The exploration can be conducted using a video camera connected to a data processing system, as described in the document FR-2 609 41 7. Cleaning a cavity with the aid of a pressurized fluid, in particular a detergent liquid, sprayed by a device that moves in the cavity is known in the art. Pressurized fluid jets can be used simultaneously to propel and stabilize the device, as described in the document FR-2 609 41 7. If the internal wall of the cavity has deteriorated, it may be necessary to fill in some depressions using mastic, as described in U.S. Pat. No. 4,782,786.

The object of a second phase is to install means for retaining the tubular member in its assigned position. This is usually a system comprising retaining members distributed regularly over the wall of the cavity. The document DE-197 01 787 describes a system which is made up of members to receive the cable and fixing means for fixing these members and comprising a closed ring made of a special steel which is elastically prestressed and pressed against the wall of the tube. The document DE-198 26 880 describes a device for retaining a cable using a shape memory plastics material which adopts the shape required to press the cable against the internal wall of the cavity due to the action of heat or moisture. This technique is costly and is justified only in the case of walls that have seriously deteriorated.

A third phase is the installation of a tubular member in the cavity. The tubular member is drawn in the cavity by mobile means and then installed and retained in the previously fixed retaining system.

An object of the present invention is to propose a method which eliminates the drawbacks of the prior art methods of installing a tubular member in a cavity that is inaccessible to an operator, such as a pipe intended to accommodate one or more cables. In particular, the invention proposes a method that is faster, safer and less costly than the prior art methods.

### SUMMARY OF THE INVENTION

The present invention provides a method of installing a tubular member in an inaccessible cavity, which method includes a step of cleaning the internal wall of the cavity, a step of bringing the tubular member into contact with retaining members, and a step of fixing the tubular member by pressing it against the wall of the cavity, and which method comprises the following three successive phases:

a first phase comprising the step of cleaning the internal wall of the cavity and a step of topographically surveying the internal wall of the cavity,

a second phase comprising a step of determining a position on the internal wall for the means for retaining the tubular member and a step of installing the retaining means on the internal wall, the retaining means comprising retaining members for retaining the tubular member and fixing means for fixing the retaining members to the wall, and

a third phase of guiding and installing the tubular member into the retaining means and comprising the step of bringing the tubular member into contact with the retaining members and the step of fixing the tubular member by pressing it against the internal wall.

In one particular embodiment, the first phase comprises the following steps:

examining the internal wall of the cavity to survey its topography,

determining operations for cleaning the internal wall of the cavity to prepare it to receive the retaining means,

cleaning the internal wall by means of a pressurized fluid jet, and

if necessary, actuating a tool for exerting a physical action on the wall.

For example, the topographical survey of the internal wall of the cavity can be effected by exploration and guidance means placed on a mobile device moving in the cavity. In the exploration mode, it can transmit data reflecting the topology of the wall of the cavity portion situated to the front of the device as it moves along to means for recording this data, such as a computer. For example, in the guidance mode, the data is viewed, for example on a screen, and the operator can therefore guide the device accurately from the outside and adapt its movement to obstacles encountered. The exploration and guidance means can be electrical but are preferably hydraulic or pneumatic. The exploration and guidance means preferably comprise an imaging device such as a video camera. In addition, illumination means can be associated with the exploration and guidance means. In the conventional way, the illumination means can comprise a light bulb connected to an electrical power supply. However, it is preferable to feed light through at least one optical fiber connected to an external light source, as this makes the operation safer by eliminating the presence of an electrical current. A data processing system can also be associated with the exploration and guidance means.

The cleaning step is carried out with the aid of a pressurized fluid jet, which can also be used to propel the cleaning means. For efficient cleaning, the cleaning means can be associated with a tool capable of exerting a physical action on the wall, such as a scraper, a wire brush, an abrasion device (glasspaper) for eliminating impediments in the form of overthicknesses, or any other instrument adapted to make even and clean the internal surface of the wall of the pipeline. A tool of the above kind can be used simultaneously with the action of the pressurized fluid jets or during a subsequent pass.

In another embodiment, the second phase comprises the following steps:

determining a location for each of the retaining means from the topographical survey of the internal wall,

preparing the locations to receive the retaining means, and

fixing the retaining means at the locations using the fixing means.

Locations for the retaining means are determined with the aid of a computer from data collected by the exploration and guidance means during the first phase. The locations determined in this way are then carefully degreased and dried in order not to compromise the fixing of the retaining members. The preparation of the internal wall at the locations determined in the above way can further comprise operations intended to facilitate the attachment of the fixing means, for example scoring the surface to roughen it.

A first variant of the second phase comprises the following steps:

determining a location for each of the retaining means from the topographical survey,

preparing the locations to receive the retaining means,

placing fixing means at the locations, and

disposing retaining members on the fixing means, so as to fix said members to the internal wall of said cavity.

A second variant of the second phase comprises the following steps:

determining a location for each of the retaining means from the topographical survey,

preparing the locations to receive the retaining means,

placing fixing means on retaining members, and

disposing the retaining members at the locations so that the fixing means are placed between the members and the internal wall of the cavity.

The retaining members are components comprising a housing intended to cooperate with the tubular member. The retaining members are preferably components whose shape is adapted to the geometry of the cavity. In particular, in a pipeline also having other functions that necessitate periodic cleaning, the shape of the retaining members is adapted to resist the cleaning means usually employed. The retaining members are preferably made of a material adapted to resist attack by the environment, in particular chemical attack, such as a plastics material like PVC. The fixing means preferably take the form of an adhesive, which can be a solvent for PVC.

In a further embodiment, the third phase comprises the following steps:

feeding the tubular member to the location of one of the retaining members by guidance means, and

pushing the tubular member toward the retaining member by means of a press until the tubular member is retained by the retaining member.

The guidance means preferably further include means for identifying the vertical, for example a spirit level. The guidance means preferably comprise a gutter along which the tubular member lies. The press is preferably a hydraulic or pneumatic press.

The method according to the present invention is preferably implemented using a device including hydraulic or pneumatic linear displacement propulsion means and hydraulic or pneumatic means for orienting it in space. This has the advantage that the device is able to move along a trajectory that is not strictly linear, for example to position itself relative to a wall or to circumvent an obstacle by diverting its trajectory horizontally and/or vertically.

The movement of the device according to the invention in the cavity must be remote-controlled. Another advantage is the absence of electrical power for driving the propulsion means and the orientation means. On the one hand, this facilitates miniaturizing the device, which is thereby able to access tubular areas whose diameter is less than 200 mm. On the other hand, this makes the device safer to use because it employs no electrical current in an area where control is difficult.

The control means preferably comprise a hydraulic or pneumatic switch, a valve and a high-pressure fluid inlet cooperating with said valve. The valve is opened and closed with the aid of a pressurized liquid in the case of a hydraulic switch or a pressurized gas in the case of a pneumatic switch. For example, the switch comprises a relatively small diameter feed tube for a fluid at a moderate pressure, communicating with the exterior. Fluid pressure is admitted into this tube from the exterior at the initiative of the operator. Opening the valve directs a high-pressure fluid jet toward the propulsion means and/or the orientation means.

The orientation means preferably comprise at least one orifice on the external lateral surface of the device and communicating with the valve on the control means. The orientation means preferably comprise a plurality of orifices, which are preferably symmetrically disposed on the periphery of the device. When the corresponding valve is opened, a pressurized fluid jet escapes forcibly via the orifice, imparting movement to the device. Depending on the disposition and the orientation of the orifice, the emission of a pressurized fluid jet causes lateral movement of the device or rotation of the device in one direction or the other. The orifice is adapted to produce a fluid jet in a particular direction: horizontal, vertical or oblique, toward the right, toward the left, upward or downward. In one embodiment of the device, the orientation of the orifices can be modified while the device is operating. In another embodiment, the power of the fluid jets emitted via the orifices can be modulated.

The propulsion means preferably comprise at least one main orifice disposed on the external surface of the device and communicating with a valve of the control means. The propulsion means preferably comprise a plurality of orifices disposed on the rear or front transverse surfaces of the device, in such a manner as to generate fluid jets for linear forward or reverse movement. The escaping fluid produces a sliding layer under the device, which helps to facilitate its movement. When the device according to the invention is used for cleaning a pipeline, for example, several successive passes in one direction and then in the opposite direction may be necessary.

In one variant, the propulsion means further comprise at least one secondary orifice disposed on the high-pressure fluid feed tube. This produces a better distribution of propulsion force, which further improves the handling characteristics of the device.

In a first embodiment, the method according to the invention uses a device further including exploration and guidance means. For example, in the exploration mode it can transmit data reflecting the topology of the location of the device to means for recording the data, such as a computer.

In the guidance mode, the data is viewed, for example on a screen, and the operator can therefore guide the device accurately from the outside and adapt its movement to obstacles encountered. The exploration and guidance means can be electrical, but are preferably hydraulic or pneumatic. The exploration and guidance means preferably comprise an imaging device such as a video camera.

A second embodiment of the method according to the invention uses a device further including illumination means. In the conventional way the illumination means can comprise an electric light bulb, but it is preferable to use at least one optical fiber fed by an external light source.

A third embodiment of the method according to the invention uses a device further including means for identifying the vertical, for example a spirit level.

The method according to the present invention can also use a device further equipped with devices providing other functions.

In a fourth embodiment of the invention, in the step of the method for cleaning soiled walls of a pipeline with a view to installing a tubular member such as a pipe intended to accommodate one or more cables, the device further includes cleaning means. The cleaning means can consist in a pressurized fluid jet. For example, the pressurized fluid jet can also be used for propulsion. The cleaning means can further include a tool capable of exerting a physical action on the wall, such as a scraper, a wire brush, an abrasion device to eliminate impediments in the form of overthicknesses, or any other instrument adapted to make even and clean the internal surface of the wall of the pipeline.

In a fifth embodiment, in the step of the method for installing a tubular member such as a pipe intended to accommodate one or more cables in a drain pipeline, the device further includes guidance means, for example a gutter, for guiding a tubular member.

In a sixth embodiment, in the step of the method for installing a tubular member such as a pipe intended to accommodate one or more cables in a drain pipeline, the device further includes means for applying a tubular member to a wall previously equipped with retaining means. The applicator means can be a hydraulic or pneumatic press, for example.

The method according to the invention is more particularly intended to be used in tubular areas having a diameter of less than 200 mm, preferably less than 150 mm, and whose diameter is preferably at least 80 mm.

Other features and advantages of the present invention will become apparent in the course of the following description with reference to the accompanying drawings of embodiments provided by way of non-limiting illustrative example.

### BRIEF DESCRIPTION OF THE DRAWINGS

FIG. 1 represents in partial section a tubular area to be equipped and symbolizes diagrammatically the three phases of installation.

FIG. 2 is a perspective view of one example of a device used to carry out the first phase.

FIG. 3 is a section of one example of a device used to carry out the second phase.

FIGS. 4A, 4B and 4C are respectively side and bottom views of one embodiment of a retaining member.

FIG. 5 is a perspective view of one example of a device used to carry out the third phase.

FIG. 6 is a perspective view of a variant of the device from FIG. 2 incorporating secondary propulsion orifices.

FIG. 7 is a section showing one embodiment of the control means of the device used to implement the method according to the invention.

FIG. 8 is a functional block diagram of the control means from FIG. 7.

FIG. 9 is a diagrammatic cross section showing the disposition of the pressurized fluid inlets of the control means from FIG. 7.

FIGS. 10A and 10B show in section two dispositions of the pressurized fluid feeds.

FIG. 11 is a diagrammatic representation of the disposition of the orifices of the orientation means of the device used to implement the method according to the invention when the latter are intended to produce lateral displacement of the device.

FIG. 12 is a diagrammatic representation of the disposition of the orifices of the orientation means of the device used to implement the method according to the invention when the latter are intended to produce rotation of the device.

### DETAILED DESCRIPTION OF THE PREFERRED EMBODIMENTS

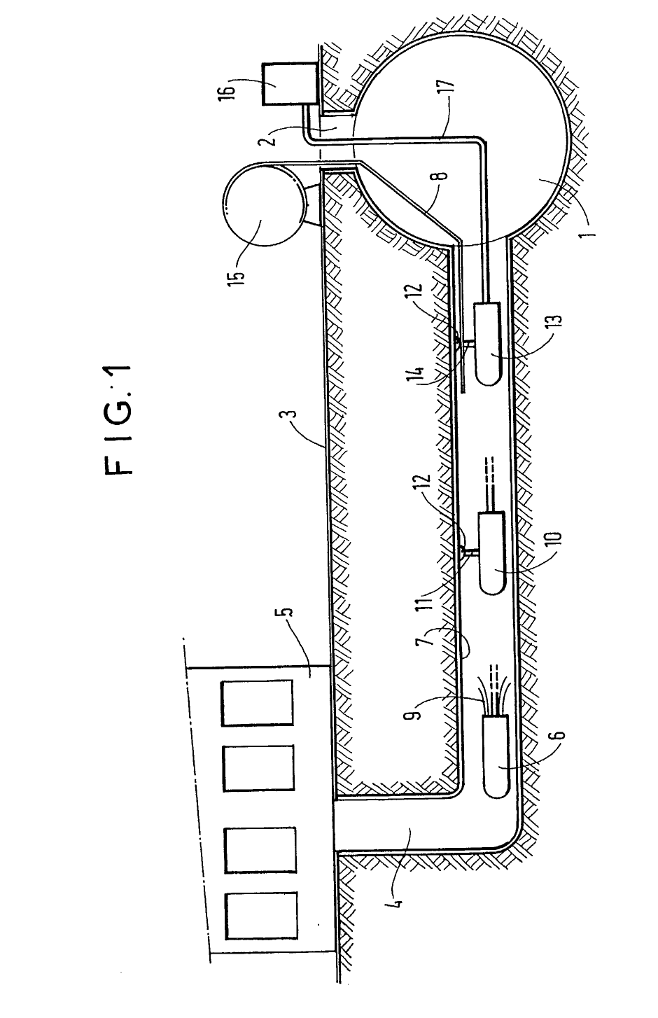

FIG. 1 shows in section an underground drainage pipeline 1 provided with an access orifice 2 leading to the surface of the ground 3. The pipeline 1 includes a smaller diameter lateral conduit 4 which connects it to a building 5. A device 6 for exploring the internal surface 7 of the conduit 4 and preparing it to receive a tubular member, as part of the first phase, is shown symbolically in the conduit 4. The tubular member can be a tube 8 made of metal, such as stainless steel, or a plastics material, for example PVC, and which is intended to accommodate one or more cables. The device 6 is a device for cleaning the internal wall 7 using a liquid jet 9, for example. Also represented symbolically is a device 10 for installing means for retaining the tubular member 8, as part of the second phase. The device 10 carries a tool 11 for installing retaining members 12, for example. Finally, there is symbolically represented a device 13 capable of guiding and installing a tubular member 8 in the third phase of the method according to the invention. The device 13 comprises a tool 14 for installing in the retaining member 12 the tubular member 8 coming from a supply 15 at the surface.

The tubular member can be a pipe intended to contain optical fiber cables, for example. The devices 6, 10 and 13 can be propelled by a fluid pressurized in a compressor 16 and fed through a pipe 17 to the corresponding device, for example.

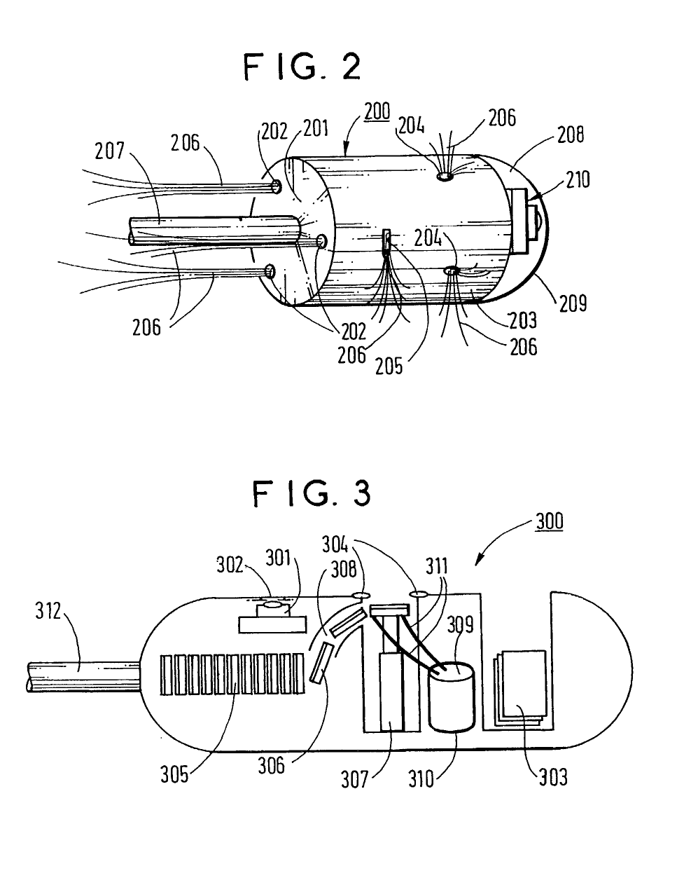

The device 200 shown in FIG. 2 is one particular embodiment of a device 6 used in the first phase of the method. On the rear transverse surface 201 of the device 200 can be seen the propulsion means, consisting of three symmetrically disposed orifices 202. On the lateral surface 203 are disposed orifices 204 for displacing the device 200 laterally and orifices 205 for rotating the device 200. Pressurized fluid jets 206 are emitted via these orifices 202, 204 and 205 to produce a thrust which moves the device 200. The pressurized fluid is fed from the exterior via a tube 207 connected to the rear of the device 200. In one variant, the device 200 is generally cylindrical and further includes at the front a compartment 208 which is protected by a rounded visor 209 and accommodates an imaging device such as a video camera 210. The visor 209 can be equipped with a cleaning system such as water jets and/or a windshield wiper, not shown.

The device 300 represented in FIG. 3 is one particular embodiment of a device 10 used in the second phase of the method. In a first step, the device 300 prepares the locations at which retaining members will be fixed, as determined following the topographical survey effected during the first phase. For example, these locations are identified by an imaging device directed toward the internal wall 7, such as a video camera 301 placed in the device 300 and protected by a port hole 302. The device 300 also comprises a rotary device 303 carrying an abrasive tool using sand, for example, glasspaper or a wire brush. The chosen location is then cleared of dust and dried by compressed air expelled through at least one orifice 304. The device further comprises a supply 305 of retaining members 306 communicating with a placement tool 307 via a passage 308 along which the members 306 are fed to the tool 307. In one particular embodiment of the invention the fixing means comprise adhesive 309 contained in a pressurized tank 310 connected by at least one pipe 311 to the upper part of the tool 307. The tool 307 is a pneumatic or hydraulic press, for example. The device 300 is propelled by the action of a pressurized fluid, in this instance preferably a gas such as air, arriving via the tube 312 communicating with the outside and connected to orifices, not shown, at the rear of the device 300. The compressed air arriving via the tube 312 can also be fed to the orifice 304.

Once introduced into the conduit 4, the device 300 is propelled by compressed air directed via the tube 312, until it reaches the chosen location identified by the video camera 301 in order to fix a retaining member 306 at that location. The admission of compressed air is interrupted and the device 303 activates the tool that it carries. The abrasion can be effected dry, in which case a pulsed air jet via the orifice 304 frees the location of dust, or in the presence of water, in which case pulsed air, preferably hot air, is used to dry the chosen location. A retaining member 306 is then sent from the supply 305 to the placement tool 307. In a first embodiment, shown in FIG. 3, adhesive 309 is deposited via the tube 311 on the surface of the member 306 that faces the internal wall 7. The retaining member 306 is then pressed onto the internal wall 7 by the tool 307.

In another embodiment, not shown, adhesive is deposited on the wall 7 at the chosen location and a retaining member 306 is pressed onto the deposit of adhesive 309 by the tool 307.

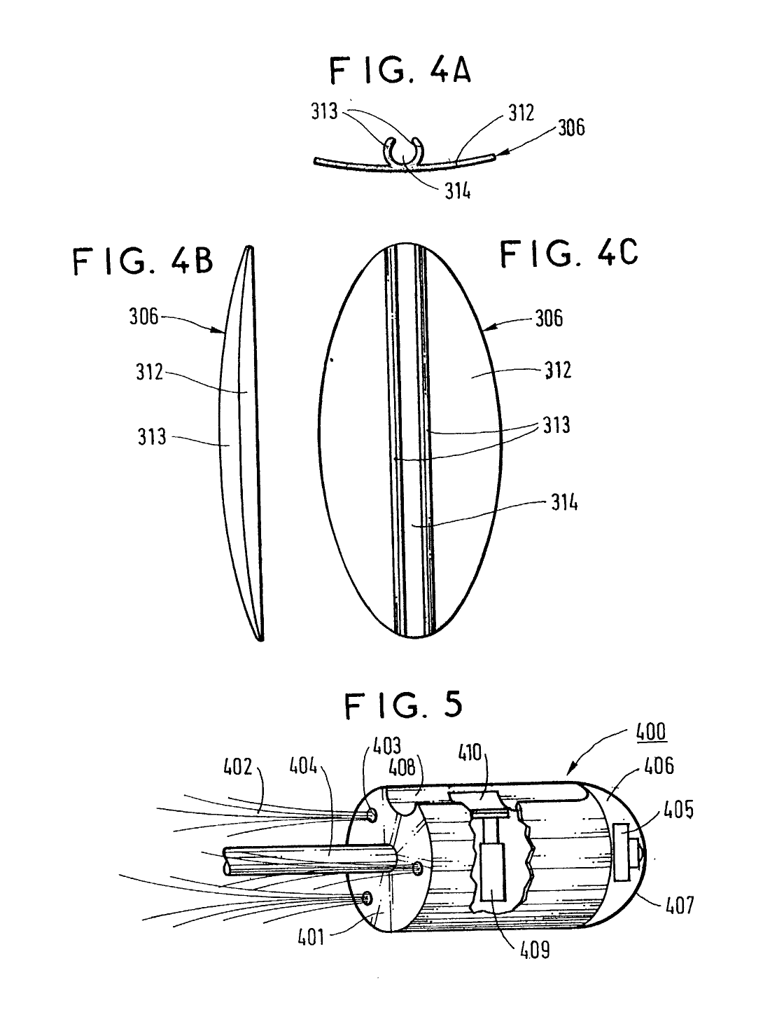

FIGS. 4A, 4B and 4C represent one particular embodiment of a retaining member 306. FIG. 4A is a side view of the retaining member 306 along a longitudinal axis of the cavity corresponding to the direction of movement of the device. The retaining member 306 has a curved base 312 espousing the profile of the wall to which it is to be fixed and an elongate retaining member 313 whose section has the shape of a split ring delimiting a housing 314 into which the tubular member is to be inserted. FIG. 4B is a side view of the retaining member 306 along a transverse axis of the cavity showing its hydrodynamic shape in the direction of movement of the device. FIG. 4C is a bottom view of the retaining member 306 showing the generally oval base 312 and the retaining member 313 exposing the housing 314 for introducing the tubular member.

The device 400 represented in FIG. 5 is one particular embodiment of a device 13 used in the third phase of the method. On the rear transverse surface 401 of the device 400 can be seen the propulsion means, consisting of pressurized fluid jets 402 expelled via three orifices 403 which are disposed symmetrically and connected to a tube 404 for feeding a pressurized fluid from the outside. The device 400 is provided with an imaging device 405 situated inside a compartment 406 situated at the front of the device and protected by a rounded visor 407. A gutter 408 is formed on the device 400 to receive and guide the tubular member 8. The interior of the device 400 is equipped with means 409 for pressing the tubular member 8 against the internal wall 7 onto which the retaining members 306 have previously been fixed. On reaching a retaining member 306, the device 400 stops its forward movement and the tubular member 8 lying along the gutter 408 is pushed vertically upward by the means 409, which comprise a press, for example, through an opening 410 in the bottom of the gutter 408. The press 409 is preferably a hydraulic or pneumatic press. To improve the accuracy with which the tubular member 8 is placed, the device 400 can be equipped with a spirit level, not shown, for identifying the vertical.

FIG. 6 shows a device 600 which is a variant of the device 200 from FIG. 2. Secondary orifices 602 can be provided in the manner shown in FIG. 6 to distribute the thrusts of the fluid jets used for propulsion over a portion of the length of the tube 601.

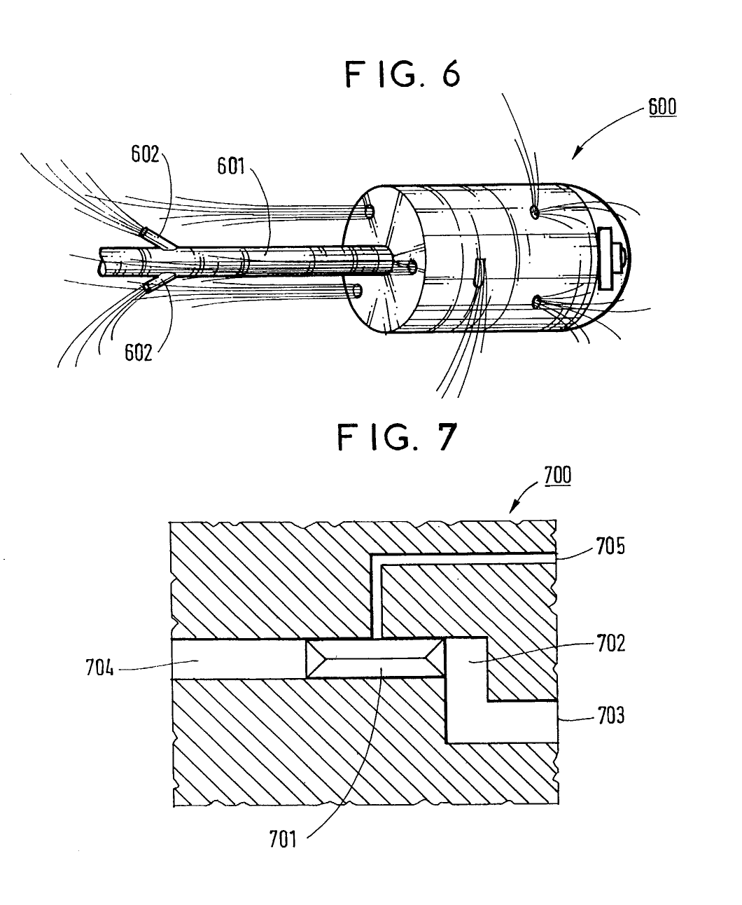

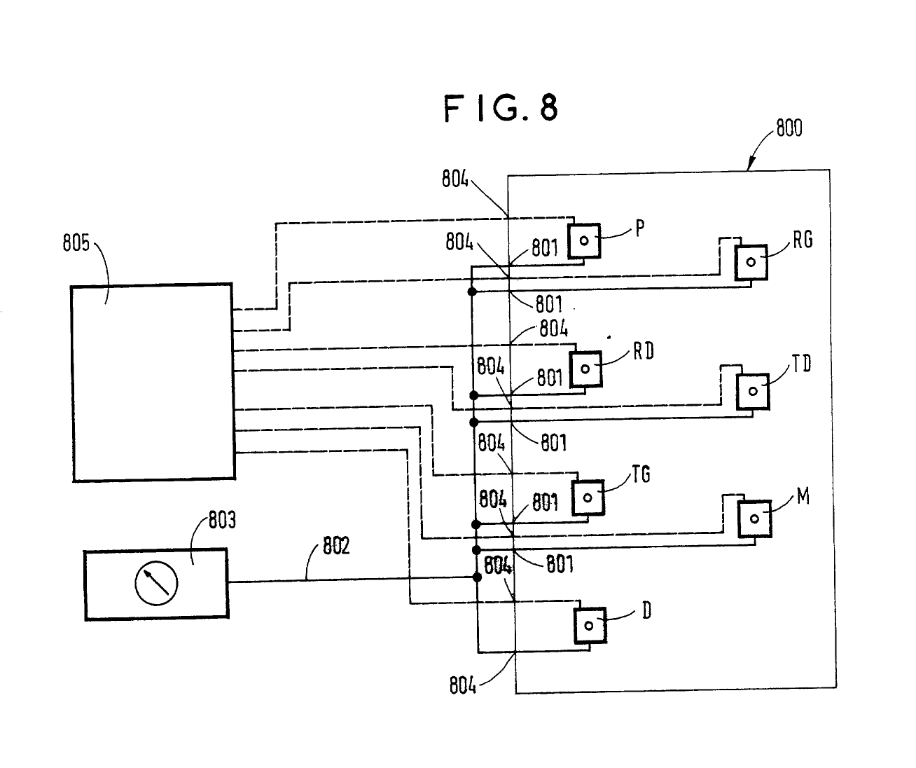

The method according to the invention is advantageously implemented by a device including control means 700 operated from the outside and whose operation is shown diagrammatically in FIGS. 7 and 8. The control means 700 for controlling the propulsion means and the orientation means of the remote-controlled device according to the invention are shown in section in FIG. 7, in which can be seen a valve 701, one end 702 of which is connected to a high-pressure fluid inlet 703, and the other end 704 of which directs the pressurized fluid jet toward an orifice of the propulsion means or the orientation means of the device. The valve 701 is actuated by the pressure of a fluid arriving via a control tube 705 serving as a switch. The valve 701 can include means enabling it to modulate the power of the fluid jet at the outlet from the end 704.

FIG. 8 shows control means 800 comprising a plurality of valves analogous to that from FIG. 2 and each communicating with one or more orifices corresponding to one movement. A valve P controls the propulsion means, valves RD and RG respectively control rotation of the device toward the right and toward the left, valves TD and TG control a horizontal movement enabling the device to turn toward the right or toward the left, and valves D and M control a vertical movement enabling the device to ascend or descend. Each of these valves is connected to the respective high-pressure fluid inlet 801. The inlets 801 communicate with a common tube 802 which feeds fluid compressed to a high pressure by an external compressor 803. Each of the valves is actuated by a fluid at a lower pressure conveyed by a control tube 804. The switching function provided by the moderate pressure fluid feed is controlled by the operator from the outside by means of a pressure switch 805 which imposes the pressure set point corresponding to the opening or closing of each valve.

The control means, the propulsion means and the orientation means of the device used in the method according to the invention use a pressurized fluid as a power supply. The propulsion fluid is fed at a high pressure such that it is possible to release a power of as much as several kW when the fluid expands to atmospheric pressure. The pressure of the fluid in the valve control tube is lower. The pressurized propulsion and orientation fluid is distributed within the device according to the invention via several inlets.

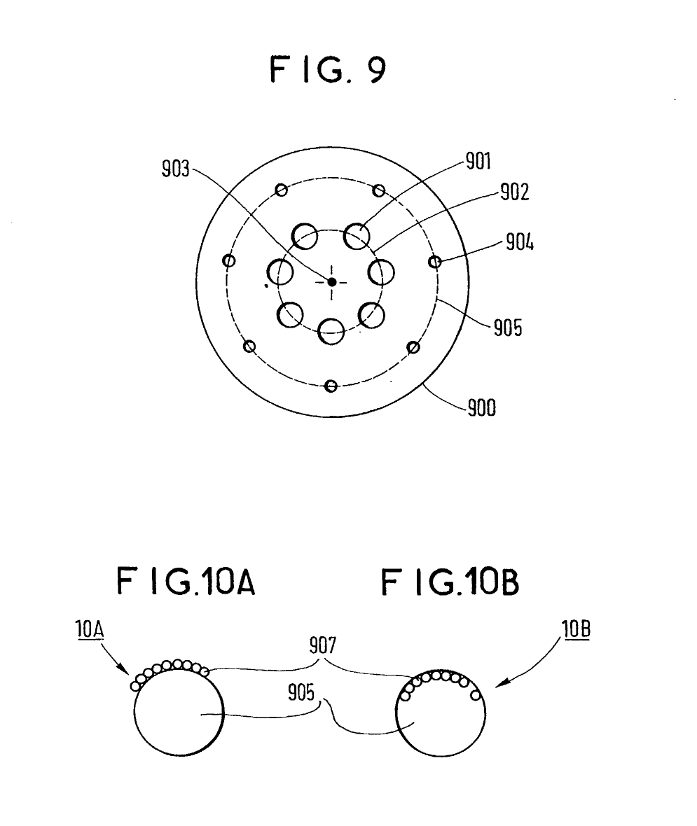

FIG. 9 shows in section one arrangement of these inlets in a cylindrical compartment 900 of the device. Inlets 901 having a diameter of the order of 12 mm, for example, and disposed on a circle 902 centered on the longitudinal axis 903 of the device feed pressurized fluid via a valve to the respective propulsion orifices or orientation orifices. Tubes 904 with a smaller diameter, of the order of 1 mm to 2 mm, and disposed on a circle 905 centered on the axis 903 admit pressurized fluid actuating the valves of the control means.

The inlets 901 are joined together at the rear of the device to form a single tube 906 that can be seen in FIGS. 10A and 10B. Each of the tubes 904 extends a tube 907 coming from the outside. The tubes 907 can be disposed around the larger diameter tube 906 to form a first variant 10A of the tube 207 from FIG. 2. The tubes 907 can also be disposed inside the tube 906 to form a second variant 10B of the tube 207 from FIG. 2. The tube 906 and the tubes 907 are preferably made from a flexible material able to follow curves resulting from the movement of the device.

FIG. 11 is a cross section showing one example of the disposition of the orifices for moving the device used in the method according to the invention vertically and horizontally. Each pair of orifices producing a fluid jet in the same direction is connected to a valve corresponding to one movement. In FIG. 11, the valve TG is open and a horizontal fluid jet 110 escapes from each of the corresponding orifices 111. Due to the action of these jets, the device turns toward the left in a horizontal plane.

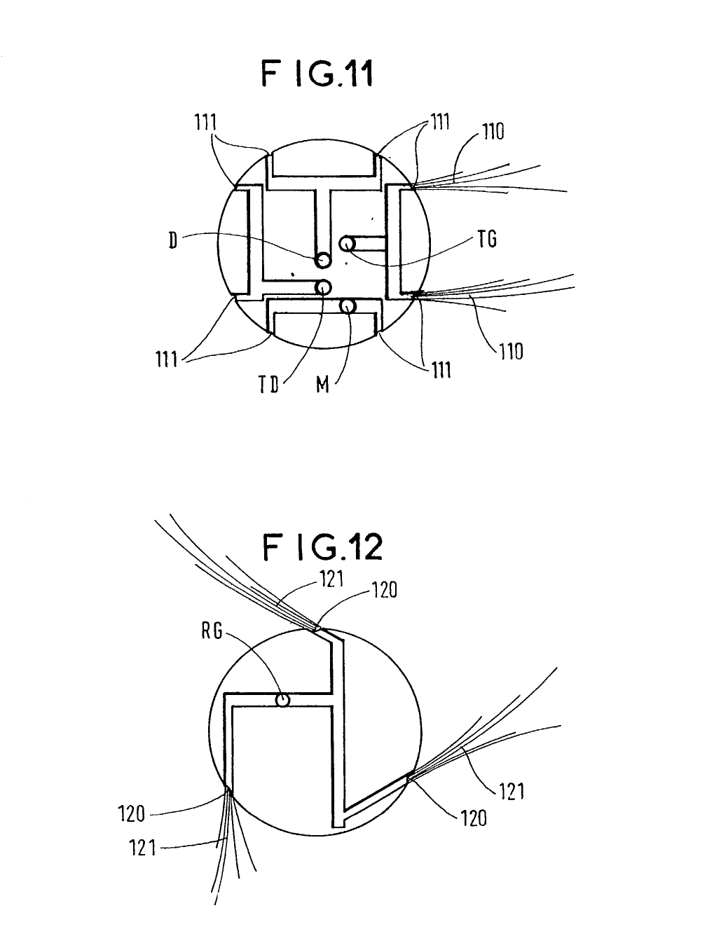

In a similar manner, in FIG. 12, the valve RG communicates with three orifices 120 that are disposed symmetrically and oriented at the same angle from 0° to 45° to the circumference of the device. In FIG. 12, the valve RG is open and a fluid jet 121 escapes in a vertical plane from each of the corresponding orifices 120. Due to the action of these jets, the device rotates clockwise in a vertical plane.

There is claimed:

1. A method of installing a tubular member in an inaccessible cavity, which method includes a step of cleaning the internal wall of said cavity, a step of bringing said tubular member into contact with retaining members, and a step of fixing said tubular member by pressing it against the wall of said cavity, and which method comprises the following three successive phases:
a first phase comprising said step of cleaning said internal wall of said cavity and a step of topographically surveying said internal wall of said cavity,
a second phase comprising a step of determining a position on said internal wall for said means for retaining said tubular member and a step of installing said retaining means on said internal wall, said retaining means comprising retaining members for retaining said tubular member and fixing means for fixing said retaining members to said wall, and
a third phase of guiding and installing said tubular member into said retaining means and comprising said step of bringing said tubular member into contact with said retaining members and said step of fixing said tubular member by pressing it against said internal wall.

2. The method claimed in claim 1 wherein said first phase comprises the following steps:
examining said internal wall of said cavity to survey its topography,
determining operations for cleaning said internal wall of said cavity to prepare it to receive said retaining means,
cleaning said internal wall by means of a pressurized fluid jet, and
if necessary, actuating a tool for exerting a physical action on said wall.

3. The method claimed in claim 1 wherein said survey is effected by exploration and guidance means.

4. The method claimed in claim 3 wherein illumination means are associated with said exploration and guidance means.

5. The method claimed in claim 4 wherein said illumination means comprise an optical fiber.

6. The method claimed in claim 3 wherein a data processing system is associated with said exploration and guidance means.

7. The method claimed in claim 1 wherein said second phase comprises the following steps:
determining a location for each of said retaining means from said topographical survey of said internal wall,
preparing said locations to receive said retaining means, and
fixing said retaining means at said locations using said fixing means.

8. The method claimed in claim 7 wherein said second phase comprises the following steps:
determining a location for each of said retaining means from said topographical survey,
preparing said locations to receive said retaining means,
placing fixing means at said locations, and
disposing retaining members on said fixing means.

9. The method claimed in claim 7 wherein said second phase comprises the following steps:
determining a location for each of said retaining means from said topographical survey,
preparing said locations to receive said retaining means,
placing fixing means on retaining members, and
disposing said retaining members at said locations so that said fixing means are placed between said members and said internal wall of said cavity.

10. The method claimed in claim 1 wherein said retaining members are components comprising a housing adapted to cooperate with said tubular member.

11. The method claimed in claim 1 wherein said fixing means comprise an adhesive.

12. The method claimed in claim 1 wherein said third phase comprises the following steps:
feeding said tubular member to the location of one of said retaining members by guidance means, and
pushing said tubular member toward said retaining member by means of a press until said tubular member is retained by said retaining member.

13. The method claimed in claim 12 wherein said guidance means comprise a gutter.

14. The method claimed in claim 12 wherein said guidance means comprise means for identifying the vertical.

15. The method claimed in claim 12 wherein said press is a hydraulic or pneumatic press.

16. The method claimed in claim 1, employing a device including hydraulic or pneumatic linear displacement propulsion means and hydraulic or pneumatic means for orienting it in space.

17. The method claimed in claim 16 wherein said control means comprise a hydraulic or pneumatic switch, a valve and a pressurized fluid inlet cooperating with said valve.

18. The method claimed in claim 16 wherein said orientation means include an orifice on the external lateral surface of said device and communicating with said valve.

19. The method claimed in claim 16 wherein said propulsion means include a main orifice on the external surface of said device and communicating with said valve.

20. The method claimed in claim 19 wherein said propulsion means further include a secondary orifice on a pressurized fluid feed tube connected to said fluid inlet.

21. The method claimed in claim 16 wherein said device further includes exploration and guidance means.

22. The method claimed in claim 21 wherein said exploration and guidance means are hydraulic.

23. The method claimed in claim 21 wherein said exploration and guidance means are pneumatic.

24. The method claimed in claim 21 wherein said exploration and guidance means comprise an imaging device.

25. The method claimed in claim 16 wherein said device further includes illumination means.

26. The method claimed in claim 25 wherein said illumination means include an optical fiber fed by an external light source.

27. The method claimed in claim 16 wherein said device further includes means for identifying the vertical.

28. The method claimed in claim 16 wherein said device further includes cleaning means.

29. The method claimed in claim 28 wherein said cleaning means comprise a pressurized fluid jet.

30. The method claimed in claim 29 wherein said pressurized fluid jet is also used for propulsion.

31. The method claimed in claim 28 wherein cleaning means include a tool adapted to exert a physical action on the wall.

32. The method claimed in claim 16 wherein said device further includes means for guiding a tubular member.

33. The method claimed in claim 16 wherein said device further includes means for applying a tubular member to a wall.

34. The method claimed in claim 1 for installing a tubular member in an inaccessible cavity having an inside diameter less than 200 mm and not less than 80 mm.
